(19) United States
(12) Patent Application Publication
(10) Pub. No.: US 2022/0238938 A1
(43) Pub. Date: Jul. 28, 2022

(54) ENERGY STORAGE DEVICE AND VEHICLE

(71) Applicant: Siemens Mobility GmbH, Muenchen (DE)

(72) Inventors: Martin Glinka, Buckenhof (DE); Mathias Wesley Schenkel, Nuernberg (DE); Stefan Teichmann, Lonnerstadt (DE)

(21) Appl. No.: 17/615,243

(22) PCT Filed: May 15, 2020
(86) PCT No.: PCT/EP2020/063603

§ 371 Date: Nov. 30, 2021

(30) Foreign Application Priority Data
May 31, 2019 (DE) 10 2019 207 998.9

(51) Int. Cl. H01M 10/6554; H01M 10/613; H01M 10/625; H01M 10/04; H01M 10/653; H01M 50/204; H01M 50/249; B61C 3/00

(52) U.S. Cl. CPC H01M 10/6554; H01M 10/613; H01M 10/625; H01M 10/0481; H01M 2220/20; H01M 50/204; H01M 50/249; B61C 3/00; H01M 10/653

(57) ABSTRACT

An energy storage device has a housing with two opposing sidewalls, a module with two opposing cooling walls which are arranged between the sidewalls, a heat sink on which the cooling walls are arranged, at least two energy storage units, which are arranged between the cooling walls and on the heat sink, and a pressure element which is arranged between the two energy storage units. The pressure element presses the energy storage units against the respectively adjacent cooling wall. Ideally, a vehicle is configured with an energy storage device of this kind.

An energy storage device is disclosed. In addition, a vehicle is disclosed.

An object to be achieved consists in the disclosure of a particularly compact energy storage device. A vehicle with an energy storage device of this kind is also to be disclosed.

The energy storage device is, for example, a battery tray, in particular a self-supporting battery tray.

According to at least one embodiment, the energy storage device comprises a housing comprising two opposing side walls. The side walls extend in a three-dimensional space with, for example, axes x, y and z, which are perpendicular to one another. Here and in the following, the axes x and y define lateral directions and the axis z a vertical direction. The side walls in each case have a main extension plane, which, for example, extends in each case, at least in places, or completely, along the axes y and z. The opposing side walls run parallel to one another, for example.

According to at least one embodiment, the energy storage device comprises a module comprising two opposing cooling walls. In this embodiment, the cooling walls are arranged between the side walls. The cooling walls extend substantially perpendicular to the side walls. Here and in the following, substantially perpendicular means that main extension planes of the elements involved enclose an angle of at least 85° and at most 95°, in particular at least 89° and at most 91°. Furthermore, the cooling walls and the side walls are, for example, in direct contact with one another. Thus, the cooling walls in each case have a main extension plane which extends, for example, along the axes x and z.

According to at least one embodiment, the module comprises a cooling plate on which the cooling walls are arranged. Here, the cooling plate is arranged between the side walls. The cooling plate extends substantially perpendicular to the side walls and the cooling walls. Thus, the cooling plate has a main extension plane which extends, for example, along the axes x and y. Furthermore, the cooling plate is, for example, in direct contact with the cooling walls and the side walls.

The cooling walls and/or the cooling plate have, for example, a particularly high thermal conductivity. For example, the cooling walls and/or the cooling plate in each case comprise a metal. The thermal conductivity is, for example, at least 10 W/(m*K), in particular at least 250 W/(m*K). Thus, heat occurring in the energy storage arrangement can advantageously be dissipated particularly well.

According to at least one embodiment, the module comprises at least two energy storage units arranged between the cooling walls and on the cooling plate. Side surfaces of the energy storage units in each case have a main extension plane which, for example, extends along the axes x and z. In this case, the side surfaces of adjoining energy storage units are arranged at a distance from one another in the direction of the axis y.

Furthermore, the side surfaces of the energy storage units in each case have a length that is only slightly shorter than a distance between the side walls. The distance between the side walls corresponds, for example, to the distance between the side walls along the axis x. Here, slightly shorter means that the length of the side surfaces of the energy storage units is at most 2 cm, in particular at most 0.2 cm, shorter than the distance between the side walls.

Furthermore, it is possible for the module to comprise more than two energy storage units. The energy storage units are, for example, arranged along a line extending along the axis y. Here, at least two directly adjoining energy storage units are arranged at a distance from one another in the direction of the axis y. Alternatively, it is possible for all directly adjoining energy storage units to be arranged at a distance from one another along the axis y.

Each of the energy storage units is, for example, formed by an array of a plurality of battery cells. The battery cells are, for example, arranged next to one another along the axis x. Furthermore, directly adjoining battery cells of an array are in direct contact with one another. The battery cells of an array are in particular connected to one another in an electrically conductive manner.

According to at least one embodiment, the module comprises a pressure element arranged between the two energy storage units. The pressure element is embodied to exert a mechanical pressure on the energy storage units in lateral directions and/or the vertical direction. The pressure element is, for example, in direct contact with the adjacent side surfaces of the energy storage units. The pressure element extends substantially perpendicular to the side walls. Thus, the pressure element has a main extension plane extending, for example, along the axes x and z. Furthermore, the pressure element is, for example, in direct contact with the adjacent side surfaces of the energy storage units. Thus, heat occurring in the energy storage units can be dissipated particularly well.

If the module comprises more than two energy storage units, the module in particular comprises more than one pressure element. In this case, a pressure element is arranged between directly adjoining energy storage units in each case. Alternatively, it is possible for the module with more than two energy storage units to have a single pressure element. In this case, the two energy storage units between which the pressure element is arranged are arranged at a distance from one another. In this case, the other energy storage units are in direct contact with one another.

According to at least one embodiment, the pressure element presses the energy storage units against the respectively adjacent cooling wall. Thus, the pressure element exerts a pressure on the energy storage units, for example, along the axis y. Here, the pressure acts on adjoining energy storage units, between which the pressure element is arranged, in opposite directions. Thus, the energy storage units are pressed against the respectively adjacent cooling walls by the pressure. Due to the pressure, the energy storage units are connected to the cooling walls in a mechanically stable manner. Thus, the energy storage units are fixed in a mechanically stable manner in lateral directions. Furthermore, the energy storage units are thus fixed in a mechanically stable manner in the vertical direction. Thus, the pressure element fixes the energy storage units by means of a press fastening. Advantageously, it is herein possible for the pressure element or the pressure elements to form the only means for mechanically fixing the energy storage units.

In at least one embodiment, the energy storage device comprises a housing comprising two opposing side walls. Furthermore, the energy storage device comprises a module comprising two opposing cooling walls arranged between the side walls, a cooling plate on which the cooling walls are arranged, at least two energy storage units arranged between the cooling walls and on the pressure plate and a pressure element arranged between the two energy storage units. Moreover, the pressure element presses the energy storage units against the respectively adjacent cooling wall.

One idea behind the energy storage device described here is inter alia that the at least two energy storage units are pressed against respectively adjacent cooling walls by the pressure element. Thus, the energy storage units are fixed by the pressure element in a mechanically stable manner in lateral directions and in the vertical direction. Fastening of this kind enables the cooling plate to have a particularly thin embodiment since it is subject to hardly any mechanical stress. Furthermore, if an energy storage unit is defective, the defective energy storage unit is particularly easy to replace since no further means for mechanical fixing—such as, for example, screws or rivets—need to be loosened.

Furthermore, the energy storage units are arranged particularly close to the cooling walls by a press fastening of this kind. This allows particularly good dissipation of heat from the energy storage units to the cooling walls. Moreover, the distance between the side walls is approximately equal to the length of the side surfaces of the energy storage units. Thus, the energy storage device advantageously has a particularly compact and space-saving embodiment.

According to at least one embodiment, the energy storage device comprises at least one further module comprising two opposing further cooling walls. In this embodiment, the further cooling walls are arranged between the side walls. The further cooling walls extend, for example, parallel to the cooling walls. The cooling walls and the side walls are, for example, in direct contact with one another. The direct contact of the side walls with the cooling walls allows particularly good heat transfer.

According to at least one embodiment, the further module comprises a further cooling plate on which the further cooling walls are arranged. Here, the further cooling plate is arranged between the side walls. The further cooling plate extends, for example, parallel to the cooling plate. The further cooling plate is, for example, in direct contact with the further cooling walls and the side walls. The direct contact of the cooling walls with the cooling plate advantageously provides a particularly good thermally conductive contact between the cooling walls and the cooling plate.

According to at least one embodiment, the further module comprises at least two further energy storage units arranged between the further cooling walls and on the further cooling plate. Side surfaces of adjoining further energy storage units are, for example, arranged at a distance from one another in the direction of the axis y. Each of the further energy storage units is, for example, formed by an array of a plurality of battery cells.

According to at least one embodiment, the further module comprises a further pressure element arranged between the two further energy storage units. The further pressure element extends, for example, parallel to the pressure element. Furthermore, the further pressure element is, for example, in direct contact with the adjacent side surfaces of the further energy storage units. Thus, heat occurring in the further energy storage units can be dissipated particularly well.

In a further embodiment, the further module comprises more than two further energy storage units. In this case, the further module comprises more than one further pressure element or one single further pressure element.

According to at least one embodiment, the further pressure element presses the further energy storage units against the respectively adjacent further cooling wall. Thus, the further pressure element, for example, exerts pressure on the further energy storage units along the axis y. The further pressure element fixes the further energy storage units in a mechanically stable manner in lateral directions and the vertical direction.

Advantageously, the further pressure element or the further pressure elements is/are, for example, the only means for mechanically fixing the further energy storage units.

According to at least one embodiment, the further module is connected to the module by the side walls in a mechanically stable manner. The further module is, for example, arranged in the vertical direction over the module. The cooling walls, the further cooling walls, the cooling plate, the further cooling plate, the energy storage units and the further energy storage units in particular have the same dimensions. Thus, the module and the further module completely overlap in lateral directions when viewed on a plane from above. In this case, the energy storage units of the module are arranged between the cooling plate of the module and the further cooling plate of the further module. Advantageously, the energy storage units can thus be cooled from two sides. This advantageously extends the life of the energy storage units as a result of which the operating costs of the energy storage units are particularly low.

The module and the further module are in each case arranged between the side walls. Here, the module and the further module are in each case connected to the side walls in a mechanically stable manner. For example, the first module and the second module are in direct contact with one another. The direct contact advantageously allows particularly good heat transfer.

Furthermore, the energy storage device can comprise a plurality of further modules. The further modules in each case have the further cooling walls, the further cooling plate, the further energy storage units and the further pressure element. In this case, the module and the further modules are connected by the side walls in a mechanically stable manner. For example, the module and the further modules are arranged one above the other in the vertical direction. For example, the further energy storage units of a further module are arranged between the further cooling plate of the further module and a further cooling plate of a further module arranged thereabove. Advantageously, thus, the further energy storage units can be cooled from two sides. Thus, the life of the further energy storage units is advantageously extended and the operating costs of the further energy storage units are thus particularly low.

According to at least one embodiment, the pressure element is, at least in places, wedge-shaped and/or, at least in places, tube-shaped. If the pressure element is, at least in places, wedge-shaped, the wedge-shaped pressure element has a tapering shape in cross section parallel to the side surfaces in the direction of the cooling plate. If a pressure element of this kind is, for example, pressed in the direction of the cooling plate, the energy storage units are advantageously pressed against the respective cooling wall.

Furthermore, it is possible for the pressure element to comprise a plurality of wedge-shaped areas. These areas are arranged next to one another between the energy storage units. Advantageously, thus, the energy storage units are pressed particularly homogeneously against the respective cooling wall.

Moreover, it is possible for an enlarged area of the pressure element facing away from the cooling plate to be embodied larger in lateral directions than a distance between the energy storage units. This enlarged area is, for example, arranged in a form-fitting manner on a top surface of the energy storage units facing away from the cooling plate. If a pressure element of this kind is, for example, pressed in the direction of the cooling plate, the energy storage units are advantageously pressed against the respective cooling wall and advantageously also pressed against the cooling plate due to the enlarged area.

If the pressure element is, at least in places, tube-shaped, the tube-shaped pressure element can be filled with a gas or a liquid. If the tube-shaped pressure element is filled, the tube-shaped pressure element advantageously presses the energy storage units against the adjacent cooling walls. Furthermore, the filled tube-shaped pressure element can be emptied so that no pressure acts on the energy storage units. Thus, it is advantageously particularly easy to replace individual energy storage units.

If, for example, the energy storage device has the module and the further module, the pressure element is preferably embodied identically for each module.

According to at least one embodiment, the energy storage units are partially surrounded by an electrically insulating insulating element. For example, a first insulating element is arranged on an inner surface of the cooling walls. Furthermore, for example, a second insulating element is arranged on an inner surface of the side walls. Thus, the energy storage units within a module are completely surrounded by the insulating element in lateral directions, for example. In this case, the first insulating element and the second insulating element are embodied to overlap in an area of an edge between the side walls and the cooling walls. In this area, the first insulating element and the second insulating element are in direct contact with one another and thus advantageously increase the tracking resistance of the energy storage device.

A third insulating element is, for example, arranged on an inner surface of the cooling plate. The third insulating element is, for example, embodied to overlap with the second insulating element in an area of an edge between the cooling plate and the side walls. In these areas, the third insulating element is in direct contact with the second insulating element. Furthermore, the third insulating element is, for example, embodied to overlap with the first insulating element in an area of an edge between the cooling plate and the cooling walls. In these areas, the third insulating element is in direct contact with the first insulating element. Thus, advantageously, the tracking resistance of the energy storage device is particularly high.

In this embodiment, the inner surface of the side wall, the inner surface of the cooling wall and/or the inner surface of the cooling plate face the energy storage units.

If the energy storage device has the further module, the further energy storage units are partially surrounded by a further electrically insulating insulating element.

According to at least one embodiment, the insulating element has an electrically insulating film. The electrically insulating film comprises, for example, electrically insulating materials and/or dielectric materials. The electrically insulating film comprises, for example, polymides and/or polyamides. The electrically insulating film has, for example, a thickness of at most 1 mm, in particular at most 0.2 mm. The low thickness means that heat occurring in the energy storage units can advantageously be dissipated particularly well to the cooling walls, the cooling plate and/or the side walls.

According to at least one embodiment, the insulating element has an electrically insulating foam. The electrically insulating foam comprises an electrically insulating material. If, for example, the module and the further module are arranged one above the other, an electrically insulating foam of this kind can advantageously be introduced particularly easily between the energy storage units and the further cooling plate.

According to at least one embodiment, an inner surface of the side wall, an inner surface of the cooling wall and/or an inner surface of the cooling plate are electrically insulating. The inner surface of the side wall, the inner surface of the cooling wall and/or the inner surface of the cooling plate comprise, for example, an electrically insulating material. For example, the side wall, the cooling wall and/or the cooling plate can, at least in places, be formed by the electrically insulating material. In this case, it is advantageously possible, at least in places, to dispense with the electrically insulating film.

According to at least one embodiment, the cooling plate comprises cooling elements. For example, the cooling plate comprises cooling ducts or heat pipes. The cooling elements are, for example, embedded in the cooling plate. Herein, embedded can mean that the cooling elements lie on the cooling plate, are arranged partially within the cooling plate, are arranged completely within the cooling plate and/or are enclosed by the cooling plate on at least one part of their outer surface. If the cooling plate has cooling ducts, a cooling inlet and a cooling outlet are arranged on the cooling plate.

Furthermore, the cooling walls can comprise further cooling elements, such as, for example, further cooling ducts or further heat pipes. The further cooling ducts of the cooling walls or the further heat pipes of the cooling walls are, for example, connected to the cooling ducts of the cooling plate or the heat pipes of the cooling plate in a thermally conductive manner. For example, the cooling ducts and the further cooling ducts or the heat pipes and the further heat pipes are embodied in one piece. Advantageously, thus, the further heat pipes can also be operated with the cooling inlet and the cooling outlet on the cooling plate.

Furthermore, it is possible for the further cooling element of the cooling walls to comprise a plurality of cooling fins which enlarge the area of the cooling walls and thus advantageously allow particularly good heat dissipation.

According to at least one embodiment, the cooling wall comprises a positioning element. The positioning element is, for example, embodied to position the further module above the module in lateral directions. The positioning element has, for example, the shape of a cylinder. The positioning element is, for example, arranged on a side surface of the cooling wall opposite the cooling plate. Furthermore, the positioning element extends, for example, along the axis z.

According to at least one embodiment, the cooling wall comprises a receptacle for a further positioning element. The receptacle for a further positioning element is, for example, a recess that extends into the cooling wall. The recess has, for example, the shape of a cylinder. In this case, a diameter of the recess is larger than a diameter of the positioning element. The recess extends, for example, from the side surface of the cooling wall opposite the cooling plate into the cooling wall in the vertical direction. The receptacle for a further positioning element is, for example, arranged at a distance from the positioning element in lateral directions.

Furthermore, the further cooling plate of the further module can comprise a further positioning element and a receptacle for a positioning element. The further positioning element is, for example, arranged on a main surface of the further cooling plate facing the cooling wall. Furthermore, the receptacle for a positioning element is, for example, a recess, and the receptacle for a positioning element is arranged on a main surface of the further cooling plate facing the cooling wall.

If the energy storage device has the module and the further module, the positioning element is introduced into the receptacle for the positioning element. Furthermore, the further positioning element is introduced into the receptacle for the further positioning element. The first module and the further module can thus advantageously be stacked one on top of the other in a particularly simple manner without the modules slipping in lateral directions during a manufacturing process.

According to at least one embodiment, the side walls, the cooling walls and the cooling plate form an interior space of the module. If the energy storage device has the further module, the side walls, the further cooling walls and the further cooling plate form a further interior space of the further module.

According to at least one embodiment, the energy storage units of the module fill at least 90% of the interior space. This means that almost the entire volume that is enclosed by the cooling plate, the cooling walls and the side walls is filled by the energy storage units. If the energy storage device has the further module, the further energy storage units of the further module fill at least 90%, in particular at least 95% of the further interior space. Advantageously, the energy storage device is thus particularly compact. A compact energy storage device of this kind enables the storage units to be embodied with a particularly high-density energy capacity. The particularly high density enables the energy storage device with the energy storage units to have a particularly light embodiment

According to at least one embodiment, the energy storage units are electrically interconnected as a traction battery. In particular, each energy storage unit and each further energy storage unit are electrically interconnected as a traction battery. A traction battery is, for example, formed by a plurality of battery cells connected together in parallel and in series. Compared to one single energy storage unit formed by the array of battery cells, the traction battery has a comparatively high output voltage. If the energy storage device has the module and the further module or the further modules, the energy storage units and the further energy storage units are electrically interconnected as a traction battery. Advantageously, particularly high voltages can be provided in this way.

According to at least one embodiment, the cooling walls are connected to the side walls by first connecting elements in a mechanically stable manner. The first connecting elements are, for example, formed by a screwed connection or a form fit or adhesive bonding or a welded connection.

According to at least one embodiment, the cooling plate is connected to the side walls by second connecting elements in a mechanically stable manner. The second connecting elements are, for example, formed by a screwed connection or a form fit or adhesive bonding or a welded connection.

According to at least one embodiment, the cooling plate is connected to the cooling walls by third connecting elements in a mechanically stable manner. The third connecting elements are, for example, formed by a screwed connection or a form fit or adhesive bonding or a welded connection.

If the energy storage device has the further module, the further cooling walls are connected to the side walls by further first connecting elements in a mechanically stable manner. Furthermore, in this case, the further cooling plate is connected to the side walls by further second connecting elements in a mechanically stable manner. The cooling plate can be connected to the further cooling walls by further third connecting elements in a mechanically stable manner.

In addition, a vehicle is disclosed that comprises an energy storage device as described herein. Therefore, all the features disclosed in connection with the energy storage device are also disclosed in connection with the vehicle and vice versa. Since the energy storage device with the energy storage units, which is, for example, built into the vehicle, is particularly light, the axle load is particularly low. Thus, the vehicle's energy consumption is advantageously particularly low. The vehicle is, for example, a rail vehicle or a motor vehicle.

Furthermore, the use of energy storage devices of this kind is intended not only for mobile energy storage, but also for stationary energy storage. The energy storage device can, for example, be used as a solar power storage system in residential buildings.

The above-described properties, features and advantages of the invention and the manner in which these are achieved will be explained in more detail by the following description of the exemplary embodiments of the invention in conjunction with the corresponding figures.

In the figures:

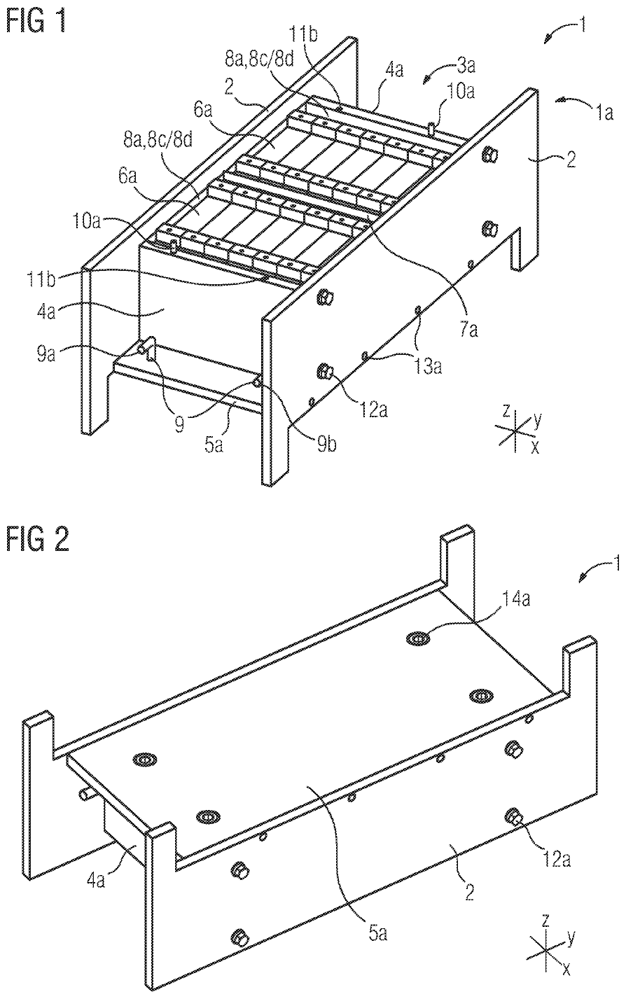

FIGS. 1, 2, 3, 4 and 5 show schematic depictions of an energy storage device according to an exemplary embodiment,

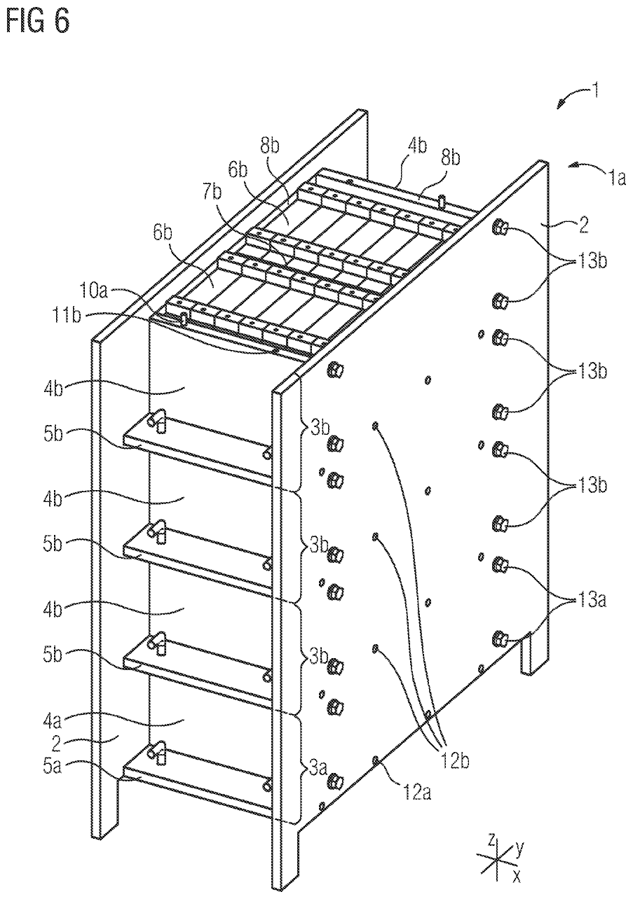

FIGS. 6, 7 and 8 show schematic depictions of an energy storage device according to an exemplary embodiment, and

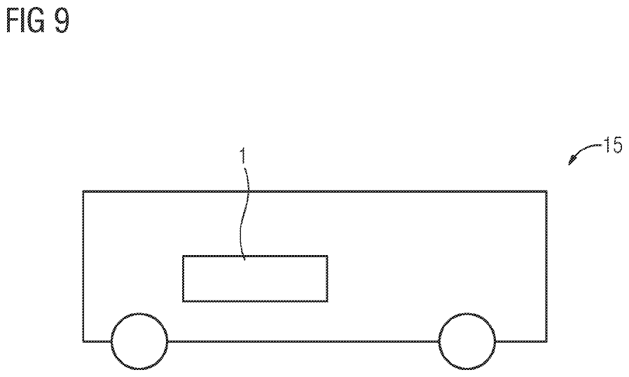

FIG. 9 shows a schematic depiction of a rail vehicle according to an exemplary embodiment.

The energy storage device 1 according to the exemplary embodiment in FIGS. 1, 2, 3, 4 and 5 comprises a housing 1a with two side walls 2, between which a module 3a is arranged. The parallel side walls 2 in each case have a main extension plane extending along the axes y and z.

The module 3a arranged therebetween comprises two opposing cooling walls 4a. The parallel cooling walls 4a are in each case arranged between the side walls 2. Furthermore, the cooling walls 4a in each case have a main extension plane extending in each case along the axes x and z. The cooling walls 4a are connected to the side walls 2 by first connecting elements 12a in a mechanically stable manner.

Furthermore, the module 3a comprises a cooling plate 5a on which the cooling walls 4a are arranged. The cooling plate 5a is also arranged between the side walls 2. Furthermore, the cooling plate 5a has a main extension plane extending along the axes x and y. The cooling plate 5a is connected to the side walls 2 by second connecting elements 13a in a mechanically stable manner. Here, the cooling plate 5a is in direct contact with the side walls 2 and the cooling walls 4a. Furthermore, the side walls 2 and the cooling walls 4a are in direct contact. Here, the side walls 2, the cooling walls 4a and the cooling plate 5b form an interior space of the module 3a.

The module 3a comprises at least two energy storage units 6a arranged between the cooling walls 4a and on the cooling plate 5b. Furthermore, the energy storage units 6a are arranged between the side surfaces 2. This means that the energy storage units 6a are arranged in the interior space of the module 3a.

An electrically insulating insulating element 8 is in each case arranged on the inner surfaces of the cooling walls 4a. on the one inner surface of the cooling plate 5a and on the inner surfaces of the side walls 2. Herein, the inner surfaces of the cooling walls 4a. the inner surface of the cooling plate 5a and the inner surfaces of the side walls 2 face the interior space of the module 3a. The electrically insulating insulating element 8 is, for example, an electrically insulating film 8c. Alternatively, the electrically insulating insulating element 8 is an electrically insulating foam 8d.

A pressure element 7a is arranged between the energy storage units 6a. The pressure element 7a is, at least in places, wedge-shaped and/or tube-shaped. If the pressure element 7a is wedge-shaped, the wedge-shaped pressure element 7a exerts a mechanical pressure on the energy storage units 6a along the axis y. The pressure element 7a presses the energy storage units 6a against the respectively adjacent cooling wall 4a along the axis y. The pressure connects the energy storage units 6a with the cooling walls 4a in a mechanically stable manner.

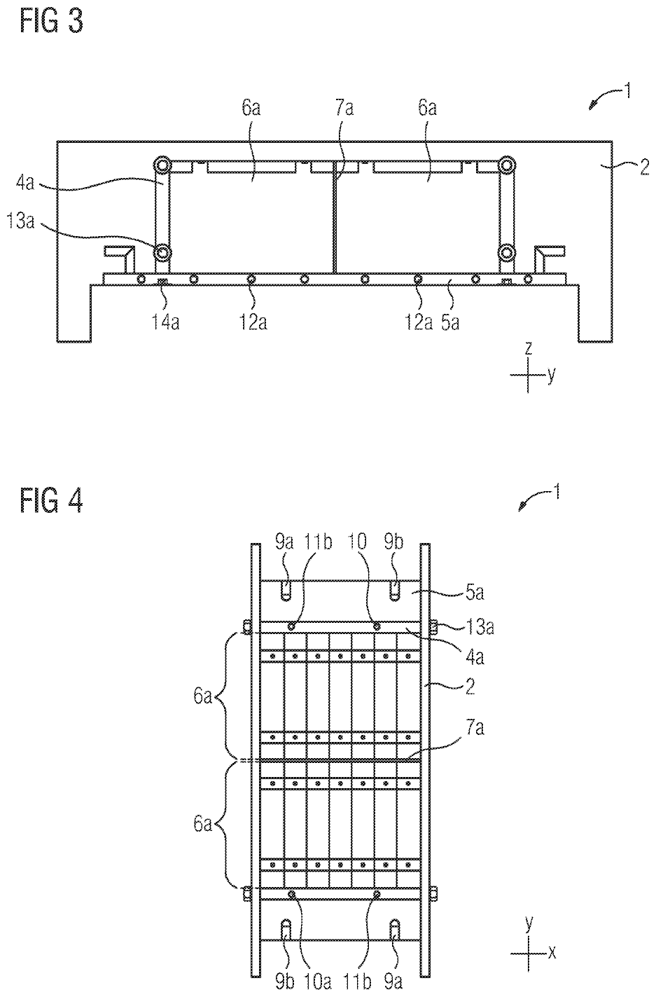

Furthermore, the cooling plate 5a is connected to the cooling walls 4a by third connecting elements 14a in a mechanically stable manner, as depicted in FIGS. 2 and 3.

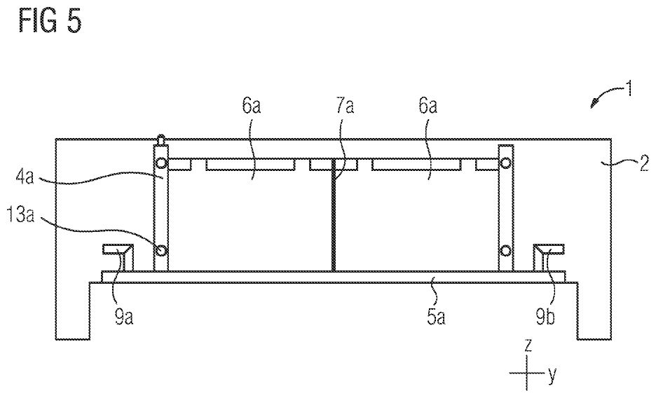

As depicted in FIGS. 4 and 5, the cooling plate 5a protrudes over the interior space bounded by the cooling walls 4a in a plane along the axes x and y. In each case, an inlet 9a and an outlet 9b for, for example, cooling liquid is arranged on the cooling plate 5a in the two protruding areas. The inlet 9a and the outlet 9b are arranged point-symmetrically on the base plate according to the top view in FIG. 4. Alternatively, it is possible for the inlets 9a and the outlets 9b to be arranged mirror-symmetrically on the base plate according to the top view in FIG. 4.

In contrast to the exemplary embodiment in FIGS. 1, 2, 3, 4 and 5, the energy storage device 1 according to the exemplary embodiment in FIGS. 6, 7, and 8 comprises further modules 3b. The further modules in each case comprise two further opposing cooling walls 4b arranged between the side walls 2. The further cooling walls 4b are arranged on each side in a common plane with the cooling walls 4a running along the axes x and z. The further cooling walls 4b are connected to the side walls 2 by further first connecting elements 12b in a mechanically stable manner.

Furthermore, each further module 3b comprises a further cooling plate 5b on which the further cooling walls 4b are arranged in each case. The further cooling plates 5b are connected to the side walls 2 by further second connecting elements 13b in a mechanically stable manner. The side walls 2, the further cooling walls 4b and the further cooling plate 5b of a further module in each case form a further interior space 3b. Two further energy storage units 6b are in each case arranged in these further interior spaces 3b.

A further electrically insulating insulating element 8b is in each case arranged on inner surfaces of the further cooling walls 4b. on inner surfaces of the cooling plate 5b and on inner surfaces of the side walls 2.

Furthermore, the further modules 3b in each case have a further pressure element 7b arranged between the energy storage units 6b. The further pressure elements 7b have the same shape as the pressure element 7a according to the exemplary embodiment in FIGS. 1, 2, 3, 4 and 5. The pressures generated by the further pressure elements 7b in each case connect the further energy storage units 6b to the respective further cooling walls 4b in a mechanically stable manner.

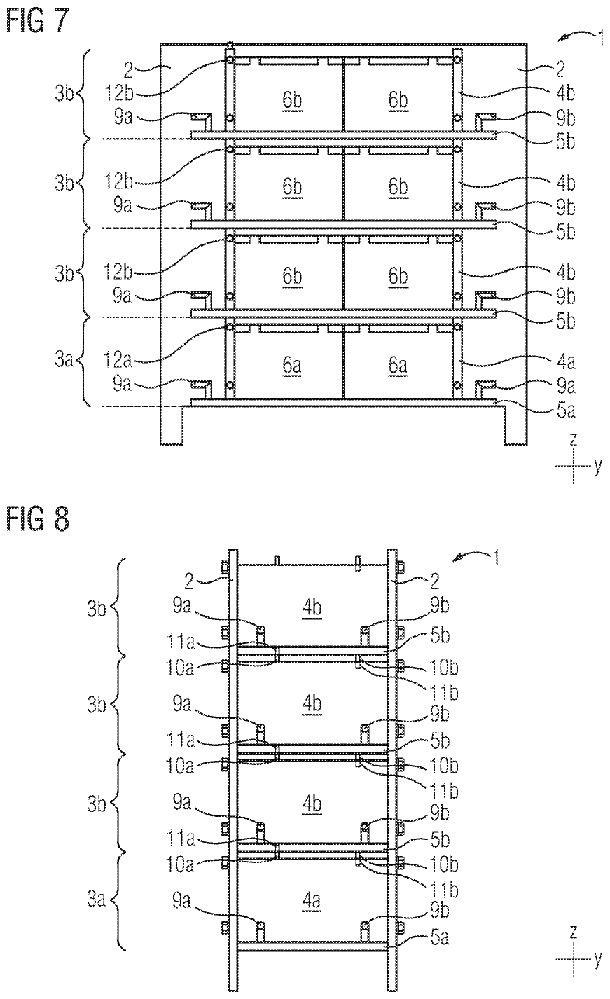

Inlets 9a and outlets 9b are in each case arranged on the further cooling plates 5b, as depicted in FIG. 7. The inlets 9a and outlets 9b are, for example, arranged in the same way as in the exemplary embodiment in FIG. 4.

As depicted in FIG. 8, the cooling wall 4a and the further cooling walls 4b in each case comprise a positioning element 10a. The cooling plate 5b and the further cooling plates 5b in each case comprise a further positioning element 10b. Furthermore, the cooling wall 4a and the further cooling walls 4b in each case comprise a receptacle for a further positioning element 11b opposite each further positioning element 10b. The cooling plate 5a and the further cooling plates 5b in each case comprise a receptacle for a positioning element 11a opposite each positioning element 10a. Here, each positioning element 10a is at least partially introduced into the respective receptacle for a positioning element 11a and each further positioning element 10b is at least partially introduced into the respective receptacle for a further positioning element 11b.

An intermediate space between a further cooling plate 5b and the energy storage units 6a is filled with an insulating element 8a. Further intermediate spaces between the further cooling plates 5b and the further energy storage units 6b are, for example, in each case filled with a further insulating element 8b.

According to the exemplary embodiment in FIG. 9, a vehicle 15, in particular a rail vehicle, comprises at least one energy storage device 1 as described here.

Although the invention was illustrated and described in more detail with reference to exemplary embodiments, the invention is not restricted to the disclosed exemplary embodiments and the specific feature combinations explained therein. Further variations of the invention can be obtained by a person skilled in the art without departing from the scope of protection of the claimed invention.

### LIST OF REFERENCE CHARACTERS

1 Energy storage device
1a Housing
2 Side walls
2a Inner surface side wall
3a Module
3b Further module
4a Cooling walls
4b Further cooling walls
4c Inner surface of cooling wall
5a Cooling plate
5b Further cooling plate
5c Inner surface of cooling plate
6a Energy storage units
6b Further energy storage units
7a Pressure element
7b Further pressure element
8a Insulating element
8b Further insulating element
8c Electrically insulating film
8d Electrically insulating foam
9 Cooling elements
9a Inlet
9b Outlet
10a Positioning element
10b Further positioning element
11a Receptacle for a positioning element
11b Receptacle for a further positioning element
12a First connecting elements
12b Further first connecting elements
13a Second connecting elements
13b Further second connecting elements
14a Third connecting elements
14b Further third connecting elements
15 Vehicle

1-14. (canceled)

15. An energy storage device, comprising:
a housing having two opposing side walls; and
a module having two opposing cooling walls disposed between said two opposing walls, a cooling plate on which said two opposing cooling walls are disposed, at least two energy storage units disposed between said two opposing cooling walls and on said cooling plate, and a pressure element disposed between said at least two energy storage units, said pressure element pressing said at least two energy storage units against a respectively adjacent one of said two opposing cooling wall.

16. The energy storage device according to claim 15, further comprising at least one further module, said at least one further module containing:
two further opposing cooling walls;
a further cooling plate, on which said two further opposing cooling walls are disposed;
at least two further energy storage units disposed between said two further opposing cooling walls and on said further cooling plate;
a further pressure element disposed between said at least two further energy storage units, wherein said further pressure element presses said at least two further energy storage units against a respectively adjacent one of said two further opposite cooling walls of said at least one further module; and
said at least one further module is connected to said module in a mechanically stable manner by said two opposing side walls.

17. The energy storage device according to claim 15, wherein said pressure element is, at least in places, wedge-shaped and/or, at least in places, tube-shaped.

18. The energy storage device according to claim 15, further comprising an electrically insulating insulating element, said at least two energy storage units being partially surrounded by said electrically insulating insulating element.

19. The energy storage device according to claim 18, wherein said electrically insulating insulating element has an electrically insulating film.

20. The energy storage device according to claim 18, wherein said electrically insulating insulating element contains an electrically insulating foam.

21. The energy storage device according to claim 15, wherein an inner surface of at least one of said two opposing side walls and/or an inner surface of at least one of said two opposing cooling walls and/or an inner surface of said cooling plate are/is are electrically insulating.

22. The energy storage device according to claim 15, wherein said cooling plate has cooling elements.

23. The energy storage device according to claim 16, wherein:
said two opposing cooling walls each have a positioning element; and
said two opposing cooling walls each have a receptacle for a further positioning element.

24. The energy storage device according to claim 15, wherein:
said two opposing side walls, said two opposing cooling walls and said cooling plate define an interior space of said module; and
said at least two energy storage units of said module fill at least 90% of said interior space.

25. The energy storage device according to claim 15, wherein said at least two energy storage units are electrically interconnected as a traction battery.

26. The energy storage device according to claim 15, further comprising:
first connecting elements, said two opposing cooling walls are connected to said two opposing side walls in a mechanically stable manner by said first connecting elements;
second connecting elements, said cooling plate is connected to said two opposing side walls in a mechanically stable manner by said second connecting elements; and
third connecting elements, said cooling plate is connected to said two opposing cooling walls in a mechanically stable manner by said third connecting elements.

27. A vehicle, comprising:
the energy storage device according to claim 15

28. The vehicle according to claim 27, wherein the vehicle is a rail vehicle.
